(19) United States
(12) Patent Application Publication
(10) Pub. No.: US 2012/0129735 A1
(43) Pub. Date: May 24, 2012

(54) NON-AQUEOUS DRILLING ADDITIVE USEFUL TO PRODUCE A FLAT TEMPERATURE-RHEOLOGY PROFILE

(75) Inventors: David Dino, Cranbury, NJ (US); Yanhui Chen, Plainsboro, NJ (US); Jeffrey Thompson, Hightstown, NJ (US)

(73) Assignee: ELEMENTIS SPECIALTIES, INC., Hightstown, NJ (US)

(21) Appl. No.: 12/950,164

(22) Filed: Nov. 19, 2010

(51) Int. Cl. C09K 8/34

(52) U.S. Cl. 507/129

(57) ABSTRACT

A method of providing a substantially constant equivalent circulating density of a drilling fluid over a temperature range of about 120° F. to about 40° F. includes adding a drilling fluid additive to the drilling fluid, wherein the drilling fluid additive includes the reaction product of a carboxylic acid with a single carboxylic moiety; and a polyamine having at least two primary amino functionalities and optionally at least one secondary amino functionality.

### BACKGROUND OF THE INVENTION

Drilling fluids have been used since the very beginning of oil well drilling operations in the United States and drilling fluids and their chemistry are an important area for scientific and chemical investigations. Certain uses and desired properties of drilling fluids are reviewed in U.S. Patent Application 2004/0110642 and 2009/0227478 and U.S. Pat. Nos. 7,345,010, 6,339,048 and 6,462,096, issued to the assignee of this application, the entire disclosures of which are incorporated herein by reference.

Nevertheless, the demands of the oil-well drilling environment require increasing improvements in rheology control over broad temperature ranges. This becomes particularly true, for example, as the search for new sources of oil involves greater need to explore in deep water areas and to employ horizontal drilling techniques.

### SUMMARY OF THE INVENTION

The present disclosure provides for a method of providing a substantially equivalent circulating density of an oil-based drilling fluid over a temperature range of about 120° F. to about 40° F. The method comprises the steps of adding a drilling fluid additive to the drilling fluid, wherein the drilling fluid additive includes a bisamide having constituent units of: a carboxylic acid unit with a single carboxylic moiety and a polyamine unit having at least two primary amino groups and optionally at least one secondary amino group.

The present disclosure provides for a method of providing a substantially equivalent circulating density of an oil-based drilling fluid over a temperature range of about 120° F. to about 40° F. The method comprises the steps of adding a drilling fluid additive to the drilling fluid, wherein the drilling fluid additive consists essentially of a bisamide having constituent units of: a carboxylic acid unit with a single carboxylic moiety and a polyamine unit having at least two primary amino groups and optionally at least one secondary amino group.

In such embodiments, the carboxylic acids may have a single carboxylic moiety and may include one or more compounds of the formula R¹—COOH wherein R¹ is a saturated or unsaturated hydrocarbon having from 12 carbon atoms to 22 carbon atoms. In another embodiment, R¹ is an unsaturated hydrocarbon having from 12 carbon atoms to 22 carbon atoms and wherein R¹ is optionally substituted with one or more hydroxyl groups. Further in such embodiments, the polyamine may have an amine functionality of two or more and may include a linear or branched aliphatic or aromatic diamine having from 2 to 36 carbon atoms.

### DETAILED DESCRIPTION OF THE EMBODIMENTS

The present invention provides for methods to impart substantially constant equivalent circulating density (“ECD”) to an oil based drilling fluid over a temperature range of about 120° F. to about 40° F. by adding a drilling fluid additive to the oil based drilling fluid. In some embodiments, a drilling fluid additive includes a reaction product of (i) a carboxylic acid with a single carboxylic moiety, and (ii) a polyamine having an amine functionality of two or more. In other embodiments, a drilling fluid additive consists of a reaction product of (i) a carboxylic acid with a single carboxylic moiety, and (ii) a polyamine having an amine functionality of two or more. In yet other embodiments, the drilling fluid additive includes a bisamide having constituent units of: a carboxylic acid unit with a single carboxylic moiety and a polyamine unit having at least two primary amino groups and optionally at least one secondary amino group. In still yet other embodiments, the drilling fluid additive includes a bisamide consisting of constituent units of: a carboxylic acid unit with a single carboxylic moiety and a polyamine unit having at least two primary amino groups and optionally at least one secondary amino group.

The carboxylic acids and polyamines which may be used to produce various embodiments of reaction products or from which the constituent units are derived are described below.

Carboxylic Acids

According to some embodiments, the carboxylic acid reactant and/or carboxylic acid from which a carboxylic acid unit is derived (individually or collectively referred to herein as “carboxylic acid”) includes various carboxylic acids having a single carboxylic moiety. In one embodiment, the carboxylic acid includes one or more compounds of the formula R¹—COOH wherein R¹ is a saturated or unsaturated hydrocarbon having from 12 carbon atoms to 22 carbon atoms. In another embodiment, R¹ is an unsaturated hydrocarbon having from 12 carbon atoms to 22 carbon atoms and wherein R¹ is optionally substituted with one or more hydroxyl groups. In yet another embodiment, the carboxylic acid includes one or more of the following monocarboxylic acids: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof. In other embodiments, the carboxylic acid includes one or more of the following monocarboxylic acids: dodecanoic acid, octadecanoic acid, docosanoic acid, 12-hydroxy-octadecanoic acid, and 12-hydroxy-9-cis-octadecenoic acid and mixtures thereof. In one embodiment, the carboxylic acid is dodecanoic acid. In another embodiment, the carboxylic acid is docosanoic acid. In another embodiment, the carboxylic acid is 12-hydroxy-octadecanoic acid.

According to some embodiments, the carboxylic acid may include a mixture of two or more carboxylic acids wherein the first carboxylic acid includes one or more compounds of the formula R¹—COOH wherein R¹ is a saturated or unsaturated hydrocarbon having from 12 carbon atoms to 22 carbon atoms and the second carboxylic acid includes one or more compounds of the formula R²—COOH wherein R² is a saturated or unsaturated hydrocarbon having from 6 carbon atoms to 10 carbon atoms. Exemplary mixtures of carboxylic acids include: dodecanoic acid/hexanoic acid; 12-hydroxy-octadecanoic acid/hexanoic acid; and 12-hydroxy-octadecanoic acid/decanoic acid.

Polyamines

According to some embodiments, the polyamine reactant and/or polyamine from which a polyamine unit is derived (individually or collectively referred to herein as “polyamine”) includes a polyamine having an amine functionality of two or more. In one embodiment, the polyamine includes a linear or branched aliphatic or aromatic diamine having from 2 to 36 carbon atoms. Di-, tri-, and polyamines and their combinations may be suitable. Examples of such amines includes one or more of the following di- or triamines: ethylenediamine, tetramethylenediamine, pentamethylenediamine, hexamethylenediamine, diethylenetriamine, metaxylene diamine, dimer diamines and mixtures thereof. In yet another embodiment, the polyamine includes one or more of the following: ethylenediamine, hexamethylenediamine, diethylenetriamine, metaxylene diamine, dimer diamines and mixtures thereof. In another embodiment, the polyamine includes a polyethylene polyamine of one or more of the following: ethylenediamine, hexamethylenediamine, diethylenetriamine and mixtures thereof.

In some embodiments, di-, tri-, and polyamines and their combinations are suitable for use in this invention. In such embodiments, polyamines include ethylenediamine, diethylenetriamine, triethylenetetramine, tetraethylenepentamine and other members of this series. In one such embodiment, a suitable triamine is diethylenetramine (DETA). DETA has been assigned a CAS No. of 111-40-0 and is commercially available from Huntsman International.

In other embodiments, a suitable polyamine includes aliphatic dimer diamine, cycloaliphatic dimer diamine, aromatic dimer diamine and mixtures thereof and Priamine® 1074 from Croda Coatings and Polymers.

Exemplary Drilling Fluid Additive Compositions

In one embodiment, the bisamide drilling fluid additive includes a compositions based on a polyethylene polyamine. In one such embodiment, the bisamide drilling fluid includes a composition having of constituent units derived from: dodecanoic acid and diethylene triamine. In another such embodiment, the bisamide drilling fluid additive includes a composition having of constituent units derived from: docosanoic acid and diethylene triamine. In another such embodiment, the bisamide drilling fluid additive includes a composition having of constituent units derived from: 12-hydroxy-octadecanoic acid and diethylene triamine. In yet another such embodiment, the bisamide drilling fluid additive includes a composition having of constituent units derived from: 12-hydroxy-octadecanoic acid, hexanoic acid and ethylene diamine. In still yet another such embodiment, the bisamide drilling fluid additive includes a composition having of constituent units derived from: 12-hydroxy-octadecanoic acid, decanoic acid and ethylene diamine.

In one embodiment, the bisamide drilling fluid additive includes a composition based on a dimer diamine. In one such embodiment, the bisamide drilling fluid includes a composition having of constituent units derived from: docosanoic acid and dimer diamine. In another such embodiment, the bisamide drilling fluid additive includes a composition having of constituent units derived from: 12-hydroxy-octadecanoic acid and dimer diamine.

Making the Drilling Fluid Additive

Specifics on processing of polyamines and carboxylic acids are well known and can be used in making the reaction product for incorporation in the drilling fluid additive. In some embodiments, the molar ratio between the amine functional group and carboxyl functional group is about 4:1 to about 1:0.5. In some embodiments, the molar ratio between the amine functional group and carboxyl functional group is about 3:1 to about 1:1. In some embodiments, the molar ratio between the amine functional group and carboxyl functional group is: about 3:1; about 2:1; and about 1:1. In some embodiments, the molar ratio between the amine functional group and carboxyl functional group is about 1:1. In some embodiments, mixtures of more than one carboxylic acid and/or more than one polyamine can be used.

Preparation of the Drilling Fluids

In some embodiments, compositions according to the present invention may be used as an additive to oil- or synthetic-based drilling fluids. In some embodiments, compositions according to the present invention may be used as an additive for oil- or synthetic-based invert emulsion drilling fluids employed in a variety of drilling applications.

The term oil- or synthetic-based drilling fluid is defined as a drilling fluid in which the continuous phase is hydrocarbon based. Oil- or synthetic-based drilling fluids formulated with over 5% water or brine may be classified as oil- or synthetic-based invert emulsion drilling fluids. In some embodiments, oil- or synthetic-based invert emulsion drilling fluids may contain water or brine as the discontinuous phase in any proportion up to about 50%. Oil muds may include invert emulsion drilling fluids as well as all oil based drilling fluids using synthetic, refined or natural hydrocarbon base as the external phase.

According to some embodiments, a process for preparing invert emulsion drilling fluids (oil muds) involves using a mixing device to incorporate the individual components making up that fluid. In some embodiments, primary and secondary emulsifiers and/or wetting agents (surfactant mix) are added to the base oil (continuous phase) under moderate agitation. The water phase, typically a brine, may be added to the base oil/surfactant mix along with alkalinity control agents and acid gas scavengers. In some embodiments, rheological additives as well as fluid loss control materials, weighting agents and corrosion inhibition chemicals may also be included. The agitation may then be continued to ensure dispersion of each ingredient and homogenize the resulting fluidized mixture.

Base Oil/Continuous Phase

According to some embodiments, diesel oil, mineral oil, synthetic oil, vegetable oil, fish oil, paraffinics, and/or ester-based oils can all be used as single components or as blends.

Brine Content

In some embodiments, water in the form of brine is often used in forming the internal phase of the drilling fluids. According to some embodiments, water can be defined as an aqueous solution which can contain from about 10 to 350,000 parts-per-million of metal salts such as lithium, sodium, potassium, magnesium, cesium, or calcium salts. In some embodiments, brines used to form the internal phase of a drilling fluid according to the present invention can also contain about 5% to about 35% by weight calcium chloride and may contain various amounts of other dissolved salts such as sodium bicarbonate, sodium sulfate, sodium acetate, sodium borate, potassium chloride, sodium chloride or formates (such as sodium, calcium, or cesium). In some embodiments, glycols or glycerin can be used in place of or in addition to brines.

In some embodiments, the ratio of water (brine) to oil in the emulsions according to the present invention may provide as high a brine content as possible while still maintaining a stable emulsion. In some embodiments, suitable oil/brine ratios may be in the range of about 97:3 to about 50:50. In some embodiments, suitable oil/brine ratios may be in the range of about 90:10 to about 60:40, or about 80:20 to about 70:30. In some embodiments, the preferred oil/brine ratio may depend upon the particular oil and mud weight. According to some embodiments, the water content of a drilling fluid prepared according to the teachings of the invention may have an aqueous (water) content of about 0 to 50 volume percent.

Organoclays/Rheological Additives Other than Organoclays

In some embodiments, the drilling fluid additive includes an organoclay. According to some embodiments, organoclays made from at least one of bentonite, hectorite and attapulgite clays are added to the drilling fluid additive. In one embodiment, the organoclay is based on bentonite, hectorite or attapulgite exchanged with a quaternary ammonium salt having the following formula:

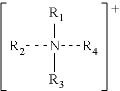

where R₁, R₂, R₃ or R₄ are selected from (a) benzyl or methyl groups; (b) linear or branched long chain alkyl radicals having 10 to 22 carbon atoms; (c) aralkyl groups such as benzyl and substituted benzyl moieties including fused ring moieties having linear or branched 1 to 22 carbon atoms in the alkyl portion of the structure; (d) aryl groups such as phenyl and substituted phenyl including fused ring aromatic substituents; (e) beta, gamma unsaturated groups; and (f) hydrogen.

In another embodiment, the organoclay is based on bentonite, hectorite or attapulgite exchanged with a quaternary ammonium ion including dimethyl bis[hydrogenated tallow]ammonium chloride (“2M2HT”), benzyl dimethyl hydrogenated tallow ammonium chloride (“B2 MHT”), trimethyl hydrogenated tallow ammonium chloride (“3 MHT”) and methyl benzyl bis[hydrogenated tallow]ammonium chloride (“MB2HT”).

There are a large number of suppliers of such clays in addition to Elementis Specialties' BENTONE® product line including Rockwood Specialties, Inc. and Sud Chemie GmbH. In addition to or in place of organoclays, polymeric rheological additives, such as THIXATROL® DW can be added to the drilling fluid. Examples of suitable polymeric rheological additives are described in U.S. Patent Application No. 2004-0110642, which is incorporated by reference herein in its entirety.

Emulsifiers

According to some embodiments, an emulsifier can also be added to the drilling fluid in order to form a more stable emulsion. The emulsifier may include organic acids, including but not limited to the monocarboxyl alkanoic, alkenoic, or alkynoic fatty acids containing from 3 to 20 carbon atoms, and mixtures thereof. Examples of this group of acids include stearic, oleic, caproic, capric and butyric acids. In some embodiments, adipic acid, a member of the aliphatic dicarboxylic acids, can also be used. According to some embodiments, suitable surfactants or emulsifiers include fatty acid calcium salts and lecithin. In other embodiments, suitable surfactants or emulsifiers include oxidized tall oil, polyaminated fatty acids, and partial amides of fatty acids.

In some embodiments, heterocyclic additives such as imidazoline compounds may be used as emulsifiers and/or wetting agents in the drilling muds. In other embodiments, alkylpyridines may be used to as emulsifiers and/or wetting agents in the drilling muds.

Industrially obtainable amine compounds for use as emulsifiers may be derived from the epoxidation of olefinically unsaturated hydrocarbon compounds with subsequent introduction of the N function by addition to the epoxide group. The reaction of the epoxidized intermediate components with primary or secondary amines to form the corresponding alkanolamines may be of significance in this regard. In some embodiments, polyamines, particularly lower polyamines of the corresponding alkylenediamine type, are also suitable for opening of the epoxide ring.

Another class of the oleophilic amine compounds that may be suitable as emulsifiers are aminoamides derived from preferably long-chain carboxylic acids and polyfunctional, particularly lower, amines of the above-mentioned type. In some embodiments, at least one of the amino functions is not bound in amide form, but remains intact as a potentially salt-forming basic amino group. The basic amino groups, where they are formed as secondary or tertiary amino groups, may contain hydroxyalkyl substituents and, in particular, lower hydroxyalkyl substituents containing up to five and in some embodiments up to three carbon atoms in addition to the oleophilic part of the molecule.

According to some embodiments, suitable N-basic starting components for the preparation of such adducts containing long-chain oleophilic molecule constituents may include but are not limited to monoethanolamine or diethanolamine.

Weighting Agents

In some embodiments, weighting materials are also used to weight the drilling fluid additive to a desired density. In some embodiments, the drilling fluid is weighted to a density of about 8 to about 18 pounds per gallon and greater. Suitable weighting materials may include barite, ilmenite, calcium carbonate, iron oxide and lead sulfide. In some embodiments, commercially available barite is used as a weighting material.

Filtrate Reducers

In some embodiments, fluid loss control materials are added to the drilling fluid to control the seepage of drilling fluid into the formation. In some embodiments, fluid loss control materials are lignite-based or asphalt-based. Suitable filtrate reducers may include amine treated lignite, gilsonite and/or elastomers such as styrene butadiene.

Blending Process

In some embodiments, drilling fluids may contain about 0.1 pounds to about 15 pounds of the drilling fluid additive per barrel of fluids. In other embodiments, drilling fluids may contain about 0.1 pounds to about 10 pounds of the drilling fluid additive per barrel of fluids, and in still other embodiments, drilling fluids may contain about 0.1 pounds to about 5 pounds of the drilling fluid additive per-barrel of fluids.

As shown above, a skilled artisan will readily recognize that additional additives such as weighting agents, emulsifiers, wetting agents, viscosifiers, fluid loss control agents, and other agents can be used with a composition according to the present invention. A number of other additives besides rheological additives regulating viscosity and anti-settling properties can also be used in the drilling fluid so as to obtain desired application properties, such as, for example, anti-settling agents and fluid loss-prevention additives.

In some embodiments, the drilling fluid additive can be cut or diluted with solvent to vary the pour point or product viscosity. Any suitable solvent or combination of solvents may be used. Suitable solvents may include but are not limited to: diesel, mineral or synthetic oils, block copolymers of EO/PO and/or styrene/isoprene, glycols including polyalkylene glycols, alcohols including polyethoxylated alcohols, polyethoxylated alkyl phenols or polyethoxylated fatty acids, various ethers, ketones, amines, amides, terpenes and esters.

Method of Use

In some embodiments, a drilling fluid additive may be added to a drilling fluid. In some embodiments, the drilling fluid additive may be added to a drilling fluid in combination with other additives, such as organoclays discussed above.

In some embodiments, a drilling fluid additive is added to a drilling fluid in an amount of about 0.1 ppb to about 30 ppb. In other embodiments, a drilling fluid additive is added to a drilling fluid in an amount of about 0.25 ppb to about 15.0 ppb. In other embodiments, a drilling fluid additive is added to a drilling fluid in an amount of about 0.25 ppb to about 5 ppb. In some embodiments, a drilling fluid additive is added to a drilling fluid in an amount of about 0.5 ppb. In some embodiments, a drilling fluid additive is added to a drilling fluid in an amount of about 0.75 ppb. In some embodiments, a drilling fluid additive is added to a drilling fluid in an amount of about 1.0 ppb. In some embodiments, a drilling fluid additive is added to a drilling fluid in an amount of about 1.5 ppb. In some embodiments, a drilling fluid additive is added to a drilling fluid in an amount of about 2.0 ppb. In some embodiments, a drilling fluid additive is added to a drilling fluid in an amount of about 5.0 ppb. In some embodiments, a smaller amount of a drilling fluid additive of the present invention is required to achieve comparable rheological stability results as a known drilling fluid additive.

The drilling fluid additive and drilling fluid may be characterized by several rheological or hydraulic aspects, i.e., ECD, high shear rate viscosity, low shear rate viscosity, plastic viscosity, regulating property viscosity and yield point, of a drilling fluid. The rheological aspects may be determined using a Fann viscometer as per standard procedures found in API RP13B-2 “Standard Procedures for Field Testing Oil-based Drilling Fluids”. Viscosity readings can be measured at 600 rpm, 300 rpm, 200 rpm, 100 rpm, 6 rpm and 3 rpm. ECD can be determined by: standard hydraulics calculations found in API RP13D “Rheology and Hydraulics of Oil-well Drilling Fluids.” For the purposes of this invention high shear rate viscosity (“HSR”) corresponds to the viscosity measured at 600 rpm as per API RP13B-2 procedures. For the purposes of this invention, low shear rate viscosity (“LSR”) corresponds to the viscosity measured at 6 rpm as per API RP 13B-2 procedures. Plastic viscosity (“PV”) corresponds to the 600 rpm reading minus the 300 rpm reading. Yield Point (“YP”) corresponds to the 300 rpm reading minus plastic viscosity.

In some embodiments, the addition of the drilling fluid additive to an oil based drilling fluid results in a substantially constant ECD as temperature is varied over a range of about 120° F. to about 40° F. Any additional ingredient which materially changes the novel characteristic of the oil based drilling fluid, of a substantially constant ECD, is excluded from the drilling fluid additive or oil-based drilling fluid. For the purposes of this invention, a substantially constant ECD may include a decrease or increase in ECD over such temperature variation. In one embodiment, the increase in ECD may include: up to 0.5%; up to 1%; up to 2%, up to 3%, up to 4%; up to 5%; up to 10%; up to 20%; up to 30%; and up to 40%. In one embodiment, the decrease in ECD may include: up to 0.5%; up to 1%; up to 2%, up to 3%, up to 4%; up to 5%; up to 10%; up to 20%; up to 30%; and up to 40%. In one embodiment, the increase in ECD may range from 1% up to 10%. In another embodiment, the increase in ECD may range from 1% up to 5%.

In some embodiments, a drilling fluid according to the present invention may have a lower viscosity at 40° F. than conventional muds formulated with sufficient organoclay to provide suspension at bottom hole temperatures. When used in drilling operations, drilling fluids according to the present invention may allow the use of a lower pumping power to pump drilling muds through long distances, thereby reducing down-hole pressures. Consequently, in some embodiments, whole mud loss, fracturing and damage of the formation are all minimized. In some embodiments, drilling fluids according to the present invention may maintain the suspension characteristics typical of higher levels of organoclays at higher temperatures. Such suspension characteristics may reduce the tendency of the mud to sag. Sag may include the migration of weight material, resulting in a higher density mud at a lower fluid fraction and a lower density mud at a higher fluid fraction. A reduction of sag may be valuable in both deep water drilling as well as conventional (non deep water) drilling. The present invention may be particularly useful in deep water drilling when the mud is cooled in the riser. A mud using a drilling fluid additive according to the present invention will maintain a reduced viscosity increase in the riser when compared to drilling fluids containing conventional rheological additives.

Blending Process

Drilling fluids preparations preferably contain between ¼ and 15 pounds of the inventive mixture per barrel of fluids, more preferred concentration is ¼ to 10 pounds-per-barrel and most preferably ¼ to 5 pounds-per-barrel.

As shown above, a skilled artisan will readily recognize that additional additives: weighting agents, emulsifiers, wetting agents, viscosifiers, fluid loss control agents, and other agents can be used with this invention. A number of other additives besides rheological additives regulating viscosity and anti-settling properties, providing other properties, can also be used in the fluid so as to obtain desired application properties, such as, for example, anti-settling agents and fluid loss-prevention additives.

The drilling fluids of the present invention generally have a lower high shear rate viscosity at 40° F. than conventional muds formulated with sufficient organoclay to provide suspension at bottom hole temperatures. When used in drilling operations, the present drilling fluids allow the use of a lower pumping power to pump drilling muds through long distances, thereby reducing down-hole pressures. Consequently, fluid loss, fracturing and damage of the formation are all minimized. Drilling fluids of the present invention also advantageously maintain the suspension characteristics typical of higher levels of organoclays at higher temperatures. The present invention is particularly useful in deep water drilling when the mud is cooled in the riser. A mud using the described invention will maintain a reduced viscosity increase in the riser when compared to drilling fluids containing conventional rheological additives. One advantage is a stable rheological profile which corresponds to a substantially constant equivalent circulating density over a temperature range of about 120° F. to about 40° F.

For the purposes of this application, the term “about” means plus or minus 10%.

### EXAMPLES

The following examples further describe and demonstrate illustrative embodiments within the scope of the present invention. The examples are given solely for illustration and are not to be construed as limitations of this invention as many variations are possible without departing from the spirit and scope thereof.

### Example 1

A drilling fluid additive was prepared as follows: To a 500 ml reaction kettle equipped with a nitrogen inlet, stirrer, Dean Stark trap and a condenser, a monocarboxylic acid was charged and heated until a molten solid was obtained while stirring at 350 rpm. A polyamine having two amine functionalities was added, at a mole ratio of monocarboxylic acid groups:amine groups ranging from 3:1 to 1:1, and mixed for 5 minutes after which time phosphoric acid was added. The reaction was heated at 200° C. for 6 hours or until the acid and amine values were less than 5. The reaction mixture was cooled to 135° C. and then discharged onto a cooling tray.

### Example 2

A drilling fluid additive was prepared as follows: to a 500 ml reaction kettle equipped with a nitrogen inlet, stirrer, Dean Stark trap and a condenser, docosanoic acid (behenic acid) (MW=340.58) was charged and heated until a molten solid was obtained while stirring at 350 rpm. Diethylene triamine (MW=103) was added and mixed for 5 minutes after which phosphoric acid was added. The reaction was heated at 200° C. for 6 hours. The reaction mixture was cooled to 135° C. and then discharged onto a cooling tray. Sample No. 3168-10.

### Example 3

A drilling fluid additive was prepared as follows: to a 500 ml reaction kettle equipped with a nitrogen inlet, stirrer, Dean Stark trap and a condenser, 12-hydroxystearic acid (MW=300.48) was charged and heated until a molten solid was obtained while stirring at 350 rpm. Diethylene triamine (MW=103) was added and mixed for 5 minutes after which time phosphoric acid was added. The reaction was heated at 200° C. for 6 hours. The reaction mixture was cooled to 135° C. and then discharged onto a cooling tray. Sample No. 3168-03.

### Example 4

A drilling fluid additive was prepared as follows: to a 500 ml reaction kettle equipped with a nitrogen inlet, stirrer, Dean Stark trap and a condenser, 12-hydroxystearic acid (MW=201.02) was charged and heated until a molten solid was obtained while stirring at 350 rpm. Priamine 1074 was added and mixed for 5 minutes after which time phosphoric acid was added. The reaction was heated at 200° C. for 6 hours. The reaction mixture was cooled to 135° C. and then discharged onto a cooling tray. Sample No. 3180-86.

### Example 5

A drilling fluid additive was prepared as follows: to a 500 ml reaction kettle equipped with a nitrogen inlet, stirrer, Dean Stark trap and a condenser, docosanoic acid (behenic acid) (MW=340.58) was charged and heated until a molten solid was obtained while stirring at 350 rpm. Priamine 1074 was added and mixed for 5 minutes after which time phosphoric acid was added. The reaction was heated at 200° C. for 6 hours. The reaction mixture was cooled to 135° C. and then discharged onto a cooling tray. Sample No. 3173-28-1.

### Example 6

A drilling fluid added was prepared following Example 1 of U.S. Pat. No. RE41,588.

Testing of Bisamide Compositions

Drilling fluids containing the bisamide compositions were prepared for evaluation based on Formulation 1 that contained a synthetic IAO as a base oil and was weighted to 14 ppg with an oil:water ratio of 85:15. The bisamide compositions were evaluated at different loading levels which were dependent upon the efficiency of each bisamide composition in combination with 6 ppb of a dialkyl quat-bentone organoclay (“organoclay”).

TABLE 1
Formulation 1

| Raw Materials | Charge (g) | |
|---|---|---|
| Base Oil: IAO | 172.1 | |
| Primary Emulsifier | 5 | MultiMixer Mix 2 min |
| 25% CaCl2 Brine | 48 | MultiMixer Mix 2 min |
| Lime | 10 | MultiMixer Mix 3 min |
| dialkyl quat-bentone | 6 | MultiMixer Mix 4 min |
| Tested Additive | (See Tables) | MultiMixer Mix 4 min |
| Weighting Agent: Barite | 337.2 | MultiMixer Mix 30 min |

The drilling fluids were dynamically aged using a roller oven for 16 hours at 150° F., 200° F. and 250° F. dependent upon the activation temperature of each bisamide composition, and then statically aged for 16 hours at 40° F. After the drilling fluids were water cooled for one hour, the fluids were mixed on a Hamilton Beach MultiMixer for 10 minutes. Viscosity measurements of the drilling fluids were measured using the Fann OFI-900 at 120° F. after each thermal cycle using test procedures API RP 13B, using standard malt cups and a 5 spindle Hamilton Beach multimixer, except for 40° F. static aging, where the viscosity measurements were made at 40° F.

### Example 7

Bisamide composition 3180-94, made from dodecanoic acid and diethylene triamine, was tested using Formulation 1 as discussed above. The rheological profile is shown below in Table 2.

TABLE 2
Concentrations

| 3180-94 | 1.3 ppb | 1.3 ppb | 1.3 ppb |
|---|---|---|---|
| BENTONE ® 38 | 6 ppb | 6 ppb | 6 ppb |
| | Initial | HR 150° F. | 40° F. |
| OFI 900 Visc. @ 120° F. | 120° F. Test | 120° F. Test | 40° F. Test |
| 600 RPM Reading | 59 | 81 | 187 |
| 300 RPM Reading | 36 | 54 | 133 |
| 200 RPM Reading | 28 | 44 | 114 |
| 100 RPM Reading | 19 | 33 | 91 |
| 6 RPM Reading | 8 | 16 | 55 |
| 3 RPM Reading | 8 | 15 | 54 |
| Apparent Visc., cPs | 30 | 41 | 94 |
| Plastic Visc., cPs | 23 | 27 | 54 |
| Yield Point, Lbs/100 ft² | 13 | 27 | 79 |
| Electrical Stability | 1050 | 1132 | — |
| 10 Sec Gel | 10 | 17 | 49 |

### Example 8

Bisamide composition 3180-95, made from dodecanoic acid and diethylene trimaine, was tested using Formulation 1 as discussed above. The rheological profile is shown below in Table 3.

TABLE 3
Concentrations

| 3180-95 | 0.35 ppb | 0.35 ppb | 0.35 ppb |
|---|---|---|---|
| BENTONE ® 38 | 6 ppb | 6 ppb | 6 ppb |
| | Initial | HR 150° F. | 40° F. |
| OFI 900 Visc. @ 120° F. | 120° F. Test | 120° F. Test | 40° F. Test |
| 600 RPM Reading | 62 | 75 | 157 |
| 300 RPM Reading | 37 | 48 | 104 |
| 200 RPM Reading | 28 | 38 | 86 |
| 100 RPM Reading | 19 | 27 | 66 |
| 6 RPM Reading | 7 | 12 | 37 |
| 3 RPM Reading | 7 | 11 | 35 |
| Apparent Visc., cPs | 31 | 38 | 79 |
| Plastic Visc., cPs | 25 | 27 | 53 |
| Yield Point, Lbs/100 ft² | 12 | 21 | 51 |
| Electrical Stability | 942 | 1112 | — |
| 10 Sec Gel | 10 | 14 | 34 |

### Example 9

Bisamide composition 3168-11, made from docosanoic acid and diethylene trimine, was tested using Formulation 1 as discussed above. The rheological profile is shown below in Table 4.

TABLE 4
Concentrations

| 3168-11 | 2.5 ppb | 2.5 ppb | 2.5 ppb |
|---|---|---|---|
| BENTONE ® 38 | 6 ppb | 6 ppb | 6 ppb |
| | Initial | HR 150° F. | 40° F. |
| OFI 900 Visc. @ 120° F. | 120° F. Test | 120° F. Test | 40° F. Test |
| 600 RPM Reading | 66 | 77 | 172 |
| 300 RPM Reading | 41 | 50 | 112 |
| 200 RPM Reading | 31 | 40 | 90 |
| 100 RPM Reading | 21 | 29 | 67 |
| 6 RPM Reading | 8 | 13 | 36 |
| 3 RPM Reading | 7 | 11 | 35 |
| Apparent Visc., cPs | 33 | 39 | 86 |
| Plastic Visc., cPs | 25 | 27 | 60 |
| Yield Point, Lbs/100 ft\hat{ }2 | 16 | 23 | 52 |
| Electrical Stability | 901 | 1068 | — |
| 10 Sec Gel | 10 | 14 | 35 |

### Example 10

Bisamide composition 3168-10 was tested using Formulation 1 as discussed above. The rheological profile is shown below in Table 5.

TABLE 5
Concentrations

| 3168-10 | 2 ppb | 2 ppb | 2 ppb |
|---|---|---|---|
| BENTONE ® 38 | 6 ppb | 6 ppb | 6 ppb |
| | Initial | HR 150° F. | 40° F. |
| OFI 900 Visc. @ 120° F. | 120° F. Test | 120° F. Test | 40° F. Test |
| 600 RPM Reading | 62 | 83 | 159 |
| 300 RPM Reading | 38 | 55 | 105 |
| 200 RPM Reading | 29 | 43 | 87 |
| 100 RPM Reading | 19 | 31 | 66 |
| 6 RPM Reading | 7 | 13 | 34 |
| 3 RPM Reading | 7 | 12 | 33 |
| Apparent Visc., cPs | 31 | 42 | 80 |
| Plastic Visc., cPs | 24 | 28 | 54 |
| Yield Point, Lbs/100 ft² | 14 | 27 | 51 |
| Electrical Stability | 978 | 1042 | — |
| 10 Sec Gel | 10 | 15 | 31 |

### Example 11

Bisamide composition 3180-86 was tested using Formulation 1 as discussed above. The rheological profile is shown below in Table 6.

TABLE 6
Concentrations

| 3180-86 | 2 ppb | 2 ppb | 2 ppb | 2 ppb |
|---|---|---|---|---|
| BENTONE ® 38 | 6 ppb | 6 ppb | 6 ppb | 6 ppb |
| | Initial | HR 150° F. | HR 250° F. | 40° F. |
| OFI 900 Visc. | 120° F. | 120° F. | 120° F. | 120° F. |
| @ 120° F. | Test | Test | Test | Test |
| 600 RPM Reading | 59 | 59 | 86 | 216 |
| 300 RPM Reading | 34 | 36 | 57 | 142 |
| 200 RPM Reading | 26 | 27 | 45 | 116 |
| 100 RPM Reading | 17 | 18 | 32 | 89 |
| 6 RPM Reading | 6 | 7 | 14 | 51 |
| 3 RPM Reading | 6 | 6 | 13 | 50 |
| Apparent Visc., cPs | 30 | 30 | 43 | 108 |
| Plastic Visc., cPs | 25 | 23 | 29 | 74 |
| Yield Point, | 9 | 13 | 28 | 68 |
| Lbs/100 ft² | | | | |
| Electrical Stability | 921 | 1084 | 1309 | — |
| 10 Sec Gel | 8 | 9 | 17 | 48 |

### Example 12

Bisamide composition 3168-03 was tested using Formulation 1 as discussed above. The rheological profile is shown below in Table 7.

TABLE 7
Concentrations

| 3168-03 | 1 ppb | 1 ppb | 1 ppb |
|---|---|---|---|
| BENTONE ® 38 | 6 ppb | 6 ppb | 6 ppb |
| | Initial | HR 150° F. | 40° F. |
| OFI 900 Visc. @ 120° F. | 120° F. Test | 120° F. Test | 40° F. Test |
| 600 RPM Reading | 77 | 83 | 240 |
| 300 RPM Reading | 50 | 55 | 164 |
| 200 RPM Reading | 40 | 45 | 135 |
| 100 RPM Reading | 29 | 32 | 106 |
| 6 RPM Reading | 13 | 15 | 61 |
| 3 RPM Reading | 12 | 13 | 62 |
| Apparent Visc., cPs | 39 | 42 | 120 |
| Plastic Visc., cPs | 27 | 28 | 76 |
| Yield Point, Lbs/100 ft² | 23 | 27 | 88 |
| Electrical Stability | 1102 | 1322 | — |
| 10 Sec Gel | 15 | 17 | 55 |

### Example 13

Bisamide composition from Example 6 was tested using Formulation 1 as discussed above. The rheological profile is shown below in Table 8.

TABLE 8
Concentrations

| Example 6 | 0.4 ppb | 0.4 ppb | 0.4 ppb |
|---|---|---|---|
| BENTONE ® 38 | 6 ppb | 6 ppb | 6 ppb |
| | Initial | HR 150° F. | HR 150° F. |
| OFI 800 Visc. @ 120° F. | 120° F. Test | 120° F. Test | 40° F. Test |
| 600 RPM Reading | 60 | 71 | 188 |
| 300 RPM Reading | 38 | 45 | 131 |
| 200 RPM Reading | 29 | 35 | 110 |
| 100 RPM Reading | 22 | 26 | 86 |
| 6 RPM Reading | 10 | 12 | 50 |
| 3 RPM Reading | 10 | 11 | 48 |
| Apparent Visc., cPs | 30 | 36 | 94 |
| Plastic Visc., cPs | 22 | 26 | 57 |
| Yield Point, Lbs/100 ft² | 16 | 19 | 74 |
| Electrical Stability | 1261 | 1344 | 1283 |
| 10 Sec Gel | 14 | 17 | 57 |

A summary of rheological properties for various bisamide compositions tested in Formula 1 is shown in Table 9. The change in ECD from 40° F. to 120° F. ranged from 2.5% to 11.9%.

TABLE 9

| | | | | Load | | | | | |
|---|---|---|---|---|---|---|---|---|---|
| | | | | Level | | | | | |
| | Carboxylic Acid | | | (PPB) | | | 120° F. ECD | | |
| | Source | Polyamine | | (B.38/ | 6 RPM | 6 RPM | HR | 40° F. | % |
| Additive | (R1) | (R2) | Activity | Additive) | 150° F. | 250° F. | (150° F./250° F.) | ECD | ΔECD |
| Organoclay | | | — | [6/0] | 7 | | 14.29 | 14.82 | 3.5 |
| Organoclay | | | — | [8/0] | 9 | | 14.40 | 15.33 | 4.7 |
| Organoclay | | | — | [9/0] | 11 | | 14.44 | 15.57 | 7.2 |
| Organoclay | | | — | [9.5/0] | 14 | | 14.49 | 15.78 | 8.1 |
| Organoclay | | | — | [10/0] | 16 | | 14.52 | 16.00 | 9.2 |
| 3173-26-3 | Lauric acid | Ethylene | 100% | [6/15] | 16 | | 14.49 | 15.56 | 11.9 |
| | | diamine | | | | | | | |
| 3173-27-1 | Lauric acid | HMDA | 100% | [6/20] | 18 | | 14.54 | 15.61 | 6.8 |
| 3173-28-1 | Behenic acid | Priamine 1074 | 100% | [6/3] | 21 | | 14.69 | 15.55 | 5.5 |
| 3173-28-2 | Behenic acid | Priamine 1074 | 100% | [6/3] | 14 | | 14.41 | 15.31 | 5.9 |
| 3173-29-2 | Behenic acid | Ethylene | 100% | [6/6] | 13 | | 14.46 | 15.10 | 4.2 |
| | | diamine | | | | | | | |
| 3173-30-3 | Behenic acid | HMDA | 100% | [6/3] | 9 | | 14.37 | 15.13 | 3.9 |
| 3173-31-3 | Ricinoleic Acid | Priamine 1074 | 100% | [6/6] | 9 | | 14.30 | 15.12 | 5.3 |
| 3173-32-2 | Ricinoleic Acid | DETA | 100% | [6/20] | 9 | | 14.31 | 15.01 | 4.7 |
| 3173-33-1 | Ricinoleic Acid | Ethylene | 100% | [6/20] | 11 | | 14.33 | 15.08 | 4.9 |
| | | diamine | | | | | | | |
| 3173-33-2 | Ricinoleic Acid | Ethylenediamine | 100% | [6/20] | 9 | | 14.31 | 14.69 | 2.5 |
| 3173-33-3 | Ricinoleic Acid | Ethylene | 100% | [6/20] | 9 | | 14.32 | 14.96 | 4.3 |
| | | diamine | | | | | | | |
| 3180-86 | 12-hydroxystearic | Priamine 1074 | 100% | [6/2] | 7 | 14 | 14.52 | 15.23 | 4.7 |
| | acid | | | | | | | | |
| 3168-03 | 12-hydroxystearic | DETA | 100% | [6/1] | 15 | | 14.50 | 15.55 | 6.7 |
| | acid | | | | | | | | |
| 3193-22-1 | 12-hydroxystearic | MXDA/DETA | 100% | [6/2] | 6 | 11 | 14.40 | 15.22 | 5.4 |
| | acid | (7/1) | | | | | | | |
| 3180-89 | Lauric acid | MXDA | 100% | [6/6] | 8 | 14 | 14.45 | 15.46 | 6.5 |
| 3180-94 | Lauric acid | DETA | 100% | [6/1.3] | 16 | | 14.50 | 15.38 | 5.7 |
| 3180-95 | Lauric acid | DETA | 100% | [6/0.35] | 12 | | 14.41 | 14.93 | 3.5 |
| 3168-04 | Behenic acid | MXDA | 100% | [6/4.5] | 6 | 12 | 14.49 | 15.10 | 4.0 |
| 3168-10 | Behenic acid | DETA | 100% | [6/2] | 13 | | 14.50 | 14.93 | 2.9 |
| 3168-11 | Behenic acid | DETA | 100% | [6/2.5] | 13 | | 14.44 | 14.96 | 3.5 |
| 3168-24 | Ricinoleic Acid | HMDA | 100% | [6/3] | 6 | 15 | 14.51 | 15.58 | 6.9 |
| 3168-25 | Ricinoleic Acid | MXDA | 100% | [6/2.5] | 12 | | 14.38 | 15.20 | 5.4 |
| Dimer | Priamine 1074 | | 100% | [6/0.4] | 11 | | 14.32 | 15.08 | |
| Diamine | | | | | | | | | |
| Example 8 | 12-hydroxystearic | Ethylene | 100% | [6/0.4] | 12 | | 14.38 | 15.29 | 5.9 |
| | acid/Hexanoic Acid | diamine | | | | | | | |
| Example | 12- | Ethylene | 100% | [6/0.4] | 11 | | 14.35 | 15.26 | 5.9 |
| 8A | hydroxyOctadecanoic | diame | | | | | | | |
| | Acid/Decanoic Acid | | | | | | | | |

Various organoclays compositions were tested with different bisamide compositions in Formulation 2 that contained a synthetic IAO as a base oil and was weighted to 14 ppg, (oil: water) (85:15). The bisamide compositions were evaluated at different loading levels which were dependent upon the efficiency of each bisamide composition in combination with varying amounts of an organoclay.

Formulation 2

| Raw Materials | Charge (g) | |
|---|---|---|
| Base Oil: IAO | 172.1 | |
| Primary Emulsifier | 5 | MultiMixer Mix 2 min |
| 25% CaCl2 Brine | 48 | MultiMixer Mix 2 min |
| Lime | 10 | MultiMixer Mix 3 min |
| Organoclay | (See Table) | MultiMixer Mix 4 min |
| Tested Additive | (See Table) | MultiMixer Mix 4 min |
| Weighting Agent: Barite | 337.2 | MultiMixer Mix 30 min |

TABLE 10

| OrganoClay | | Polymeric Additive | | HR at 150° F. | | Static Aging at 40° F. | | |
|---|---|---|---|---|---|---|---|---|
| Type | Conc. (PPB) | Name | Conc. (PPB) | 600 RPM | 6 RPM | 600 RPM | 6 RPM | ECD (PPG) |
| alkyl quat- | 15.0 | | 0.0 | 54 | 7 | 164 | 31 | 14.95 |
| attapulgite | | | | | | | | |
| alkyl quat- | 22.0 | | 0.0 | 78 | 12 | 255 | 66 | 16.22 |
| attapulgite | | | | | | | | |
| alkyl quat- | 15.0 | 3180-95 | 0.4 | 76 | 14 | 175 | 35 | 15.03 |
| attapulgite | | | | | | | | |
| alkyl quat- | 15.0 | 3168-10 | 2.0 | 67 | 11 | 185 | 48 | 15.56 |
| attapulgite | | | | | | | | |
| alkyl quat- | 4.0 | | 0.0 | 53 | 5 | 129 | 15 | 14.51 |
| bentone | | | | | | | | |
| alkyl quat- | 8.0 | | 0.0 | 106 | 17 | 214 | 44 | 15.50 |
| bentone | | | | | | | | |
| alkyl quat- | 4.0 | 3180-95 | 0.4 | 70 | 14 | 129 | 19 | 14.65 |
| bentone | | | | | | | | |
| alkyl quat- | 4.0 | 3168-10 | 2.0 | 78 | 15 | 182 | 24 | 14.85 |
| bentone | | | | | | | | |
| benzyl quat- | 6.0 | | 0.0 | 63 | 8 | 127 | 13 | 14.55 |
| bentone | | | | | | | | |
| benzyl quat- | 9.0 | | 0.0 | 94 | 16 | 206 | 25 | 14.91 |
| bentone | | | | | | | | |
| benzyl quat- | 6.0 | 3180-95 | 0.4 | 62 | 9 | 138 | 17 | 14.58 |
| bentone | | | | | | | | |
| benzyl quat- | 6.0 | 3168-10 | 2.0 | 75 | 12 | 144 | 14 | 14.59 |
| bentone | | | | | | | | |

The results in Table 10 illustrate that the bisamide compositions are effective when used in combination with a variety of organoclays.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modifications will be apparent to those skilled in the art, and may be made without departing from the spirit or scope of the disclosure.

We claim:

1. A method of providing a substantially equivalent circulating density of an oil-based drilling fluid over a temperature range of about 120° F. to about 40° F. comprising adding a drilling fluid additive to the drilling fluid, wherein the drilling fluid additive comprises a bisamide comprising constituent units of:
(a) a carboxylic acid unit with a single carboxylic moiety and
(b) a polyamine unit having at least two primary amino groups and optionally at least one secondary amino group.

2. The method of claim 1, wherein the carboxylic acid unit is derived from one or more compounds of the formula R¹—COOH wherein R¹ is a saturated or unsaturated hydrocarbon having from 12 carbon atoms to 22 carbon atoms.

3. The method of claim 2, wherein R¹ is an unsaturated hydrocarbon having from 12 carbon atoms to 22 carbon atoms and wherein R¹ is optionally substituted with one or more hydroxyl groups.

4. The method of claim 1, wherein the carboxylic acid unit is derived from a monocarboxylic acid selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

5. The method as in either claim 1 or claim 4, wherein the polyamine unit is derived from a linear or branched aliphatic or aromatic diamine having from 2 to 36 carbon atoms.

6. The method of claim 5, wherein the polyamine unit is derived from a polyamine selected from a group consisting of ethylenediamine, tetramethylenediamine, pentamethylenediamine, hexamethylenediamine, diethylenetriamine, metaxylene diamine and mixtures thereof.

7. The method of claim 1, further comprising adding one or more emulsifiers to the oil-based drilling fluid.

8. The method of claim 1, further comprising adding an organoclay to the oil-based drilling fluid.

9. The method of claim 1, further comprising adding a non-organoclay rheological additive to the oil-based drilling fluid.

10. The method of claim 1, further comprising adding a fluid loss reducing additive to the oil-based drilling fluid.

11. The method of claim 1, comprising adding less than about 2 ppb drilling fluid additive to the oil-based drilling fluid.

12. A method of providing a substantially constant equivalent circulating density of an oil-based drilling fluid over a temperature range of about 120° F. to about 40° F. comprising adding a drilling fluid additive to the drilling fluid, wherein the drilling fluid additive comprises a reaction product of:
(a) a carboxylic acid with a single carboxylic moiety and
(b) a polyamine having at least two primary amino groups and optionally at least one secondary amino group.

13. The method of claim 12, wherein the carboxylic acid has a formula R¹—COOH wherein R¹ is a saturated or unsaturated hydrocarbon having from 12 carbon atoms to 22 carbon atoms.

14. The method of claim 13, wherein R¹ is an unsaturated hydrocarbon having from 12 carbon atoms to 22 carbon atoms and wherein R¹ is optionally substituted with one or more hydroxyl groups.

15. The method of claim 12, wherein the carboxylic acid unit is selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

16. The method as in either of claim 12 or claim 15, wherein the polyamine comprises a linear or branched aliphatic or aromatic diamine having from 2 to 36 carbon atoms.

17. The method of claim 16, wherein the polyamine selected from a group consisting of ethylenediamine, tetramethylenediamine, pentamethylenediamine, hexamethylenediamine, diethylenetriamine, metaxylene diamine and mixtures thereof.
